(19) United States
(12) Patent Application Publication
(10) Pub. No.: US 2003/0088394 A1
(43) Pub. Date: May 8, 2003

(54) Efficient construction of passive macromodels for resonant networks

(76) Inventors: Sung-Hwan Min, Atlanta, GA (US); Madhavan Swaminathan, Marietta, GA (US)

Correspondence Address: THOMAS, KAYDEN, HORSTEMEYER & RISLEY, LLP, 100 GALLERIA PARKWAY, NW, STE 1750, ATLANTA, GA, 30339-5948, US

(21) Appl. No.: 10/273,028

(22) Filed: Oct. 17, 2002

Related U.S. Application Data
(60) Provisional application No. 60/329,884, filed on Oct. 17, 2001.

(51) Int. Cl. G06F 17/50

(52) U.S. Cl. 703/14

(57) ABSTRACT

The present invention provides a system and method that provides a model that simulates response of a multi-port passive circuit over a broadband frequency range. Briefly described, one embodiment comprises determining a plurality parameters of a model corresponding to the multi-port passive circuit, determining a plurality of pole-residue-eigenvalues associated with the determined parameters, identifying at least one pole-residue-eigenvalue having a magnitude less than zero, changing a value of the at least one identified pole-residue-eigenvalue and recalculating at least one of the parameters after the setting the identified pole-residue-eigenvalue to at least zero.

### CLAIM OF PRIORITY

This application claims priority to copending U.S. provisional application entitled, “EFFICIENT CIRCUIT SIMULATION TECHNIQUE USING MACROMODELS” having ser. No. 60/329,884, filed Oct. 17, 2001, which is entirely incorporated herein by reference.

### STATEMENT REGARDING FEDERALLY SPONSORED RESEARCH OR DEVELOPMENT

The U.S. government has a paid-up license in this invention and the right in limited circumstances to require the patent owner to license others on reasonable terms as provided for by the terms of [contract no. or grant no.] awarded by the [agency] of the U.S.

### TECHNICAL FIELD

The present invention is generally related to network modelers and, more particularly, is related to a system and method for construction of passive macromodels for resonant networks.

### BACKGROUND OF THE INVENTION

Measured data may be obtained from a device, component or element, using a vector network analyzer (VNA). A circuit model of the device, component or element may need to be integrated into a circuit simulator. Similarly, modeled data from a field solver may need to be integrated into a circuit simulator. In such cases, a macromodel generated using rational functions is useful since it provides a good approximation to the frequency response over a frequency range of interest. However, traditional circuit macromodels are valid only over limited frequency ranges.

As frequencies change from the frequency for which the model was designed, errors in the distributed and resonant behavior of the frequency response become apparent. This phenomenon is typical in transmission lines and power distribution networks. Definition of stable and passive macromodels for such linear passive networks can be difficult.

Some macromodels may become unstable at higher frequencies. Also, the macromodels may not exhibit good passivity. Passivity requires that when a passive circuit is excited by an input signal, the output signal from the circuit over time does not exceed the energy of the input signal. That is, the circuit does not generate energy. Accordingly, a macromodel that fails to provide desirable passive behavior at a specific frequency may generate energy. This energy may be manifested as an amplified sinusoidal waveform. Such macromodels, although reasonably valid at lower frequencies, are not valid over a very broad band of frequencies.

Macromodels for multi-port networks using orthogonal polynomials increase modeling accuracy. However, such constructed macromodels do not ensure the passivity of the circuit. Moreover, extracting circuit equivalent models can be difficult.

Another method for enforcing passivity of a macromodel may be implemented by manipulating the eigenvalue of the admittance matrix. Though this method enforces passivity within the computational frequency domain, such a model may lose the passivity properties outside of the computational frequency domain. Accordingly, this method is limited to the frequency bandwidth of interest and does not guarantee the passivity outside this frequency band. This limitation can create problems since unstable poles outside of the computational frequency band can result in a non-passive transient response. Moreover, such macromodels are generally limited to low-order systems containing at most 20-30 poles.

### SUMMARY OF THE INVENTION

The present invention is directed to a system and a method that provide a model that simulates response of a multi-port passive circuit over a broadband frequency range. Briefly described, one embodiment comprises determining a plurality parameters of a model corresponding to the multi-port passive circuit, determining a plurality of pole-residue-eigenvalues associated with the determined parameters, identifying at least one pole-residue-eigenvalue having a magnitude less than zero, changing a value of the at least one identified pole-residue-eigenvalue and recalculating at least one of the parameters after the setting the identified pole-residue-eigenvalue to at least zero.

### BRIEF DESCRIPTION OF THE DRAWINGS

The components in the drawings are not necessarily to scale relative to each other. Like reference numerals designate corresponding parts throughout the several views.

FIG. 1 is Equation (5) and Equation (9).

FIG. 2 is a block diagram illustrating resonance in a hypothetical power distribution system.

FIG. 3 is a table of extracted poles and residues of the macromodel of FIG. 2.

FIG. 4 are graphs of eigenvalues 401-404 extracted from the frequency response of macromodels over a bandwidth of 10 giga-hertz (GHz).

FIG. 5 illustrates the transient response for a two-port macromodel having the eigenvalues of FIG. 4.

FIG. 6 is a graph illustrating a minimum eigenvalue in a solution area.

FIG. 7 is Equation (28).

FIG. 8 illustrates the construction of a plurality of sub-bands.

FIG. 9 is a is a flow chart illustrating the frequency slicing and frequency sliding method of constructing a macromodel in accordance with the present invention.

FIG. 10 is a is a flow chart illustrating the drop-pick method of constructing a macromodel in accordance with the present invention.

FIG. 11 is a block diagram illustrating an embodiment of the present invention implemented as a processor system 1100.

FIG. 12 illustrates an exemplary transmission line.

FIGS. 13 and 14 are comparison plots between the original frequency response data and constructed macromodels for Y14 admittance parameters, real and imaginary, respectively, over 10 GHz bandwidth.

FIG. 15 is a plot of eigenvalues for the original frequency response data and constructed macromodels.

FIG. 16 is a block diagram of a macromodel of the transmission line of FIG. 12.

FIG. 17 is a time-domain plot for the macromodel of FIG. 16 when passivity is not enforced in accordance with the present invention.

FIG. 18 is a time-domain plot for the macromodel of FIG. 16 when the multi-port broadband macromodel enforces passivity in accordance with the present invention.

### DETAILED DESCRIPTION OF THE PREFERRED EMBODIMENT

Embodiments of the present invention define a stable and passive broadband macromodel over a large frequency band. The large frequency band is hereinafter referred to as a broadband. A valid broadband macromodel, defined in accordance with the present invention, is stable and exhibits passivity over the entire broadband.

Passivity is a condition that, when the broadband macromodel is excited by an input signal, the output signal from the circuit over time, for all frequencies of the broadband, does not exceed the energy of the input signal. That is, the circuit does not generate energy. Accordingly, a macromodel that fails to provide desirable passive behavior at a specific frequency generates energy. Eigenvalues determined from electromagnetic simulation or by measurement of a device, circuit or component are referred to herein as data-eigenvalues for convenience. Eigenvalues analytically-determined from the poles and residues are referred to herein as pole-reside-eigenvalues for convenience, pole-residue-eigenvalues are independent of a specific frequency.

In an embodiment of a single-port broadband macromodel, a two-port broadband macromodel, or a multi-port broadband macromodel that has been defined, the model data is analytically determined such that passivity is enforced. Passivity is enforced on the coefficients of a pole-residue form of broadband macromodels by directly setting selected residues to zero for violating passivity in selected poles for the single-port broadband macromodel and the two-port broadband macromodel.

In complex multi-port broadband macromodels, determination of the circuit model of poles and residues are very difficult, if not impossible, using conventional techniques. Accordingly, one embodiment of the present invention, using frequency data obtained from an electromagnetic simulation or by measurement of a device, circuit or component, determines poles and residues of a plurality of sub-bands across the broadband frequency spectrum (referred to herein as parameters for convenience). The data-eigenvalues at a specific frequency are determined from the poles and residues in order to satisfy desirable passive behavior over the broadband frequency spectrum. Pole-residue-eigenvalues are analytically derived from the values of poles and residues. In one embodiment, passivity is enforced by setting negative pole-residue-eigenvalues to zero or a suitable positive value, and by reconstructing the poles and residues for the multi-port broadband macromodel using compensated pole-residue-eigenvalues.

In another embodiment, described in greater detail herein, sub-band pole-residue-eigenvalues are determined from the poles and residues. The determined sub-band pole-residue-eigenvalues are compiled over the broadband frequency spectrum. Passivity is enforced by setting negative pole-residue-eigenvalues (values generated from poles and residues) to zero or a suitable positive value and by reconstructing the poles and residues for the multi-port broadband macromodel using compensated sub-band pole-residue-eigenvalues. The circuit model of poles and residues is then determined. The determination of the sub-bands from the broadband frequency spectrum is referred to herein as frequency slicing.

In another embodiment, frequency sliding is employed to better determine the data-eigenvalues and/or pole-residue-eigenvalues of a multi-port broadband macromodel. Accordingly, during the determination of poles and residues for a sub-band, the upper and lower frequency values are increased and/or decreased together by suitable values, thereby “sliding” the sub-band over the frequency spectrum to further determine more accurate the data-eigenvalues and/or pole-residue-eigenvalues of the broadband frequency spectrum. Passivity is enforced by setting negative pole-residue-eigenvalues to zero or a suitable positive value and by reconstructing the poles and residues using compensated pole-residue-eigenvalues. That is, the determined poles and residues are added back into the model.

In another embodiment, a “pick and drop” technique is employed to further improve the accuracy of the determined poles and residues. As described in greater detail below, poles and residues having error are identified. An error is identified by comparing frequency data obtained from the multi-port broadband macromodel, which provides poles and residues, with frequency data obtained from an electromagnetic simulation or by measurement of a device, circuit or component (referred to herein as original poles, original residues and original data-eigenvalues for convenience). A sub-band around the poles and residues having error is defined. More accurate poles and residues are then determined for the multi-port broadband macromodel. Passivity is enforced by setting negative pole-residue-eigenvalues to zero or a suitable positive value and by reconstructing the poles and residues for the multi-port broadband macromodel using compensated pole-residue-eigenvalues.

The derivation for a single-port broadband macromodel and a two-port broadband macromodel that are stable and passive is now presented. Using rational functions, the frequency response H(s) of any linear passive network can be represented as:

$$H ( s ) = \frac{{\sum }_{n s = 0}^{NS} {a}_{n s} {s}^{n s}}{{\sum }_{ds = 0}^{DS} {b}_{ds} {s}^{ds}} \qquad ( 1 )$$

where

s=jω, ω is the angular frequency in radians per second and [a]=[a₀ a₁ . . . a_{NS}]^{T} and [b]=[b₀ b₁ . . . b_{DS}]^{┌} are unknown real coefficient column vectors. In (1), H(s) can be S, Y or Z parameters generated from measurements or electromagnetic simulation. The goal of solving Equation (1) is to obtain the orders NS, DS and the coefficient vectors [a], [b] based on the input data H(s).

Equation (1) can be rewritten as a matrix equation in the form:

$$( \begin{matrix}real [ {\sum }_{n s = 0}^{NS} {( j {ω}_{1} )}^{n s} ] - real [ {H}_{11} ( j {ω}_{1} ) {\sum }_{ds = 0}^{DS} {( j {ω}_{1} )}^{ds} ] \\ imag [ {\sum }_{n s = 0}^{NS} {( j {ω}_{1} )}^{n s} ] - imag [ {H}_{11} ( j {ω}_{1} ) {\sum }_{ds = 0}^{DS} {( j {ω}_{1} )}^{ds} ] \\ real [ {\sum }_{n s = 0}^{NS} {( j {ω}_{2} )}^{n s} ] - real [ {H}_{11} ( j {ω}_{2} ) {\sum }_{ds = 0}^{DS} {( j {ω}_{2} )}^{ds} ] \\ imag [ {\sum }_{n s = 0}^{NS} {( j {ω}_{2} )}^{n s} ] - imag [ {H}_{11} ( j {ω}_{2} ) {\sum }_{ds = 0}^{DS} {( j {ω}_{2} )}^{ds} ] \\ ⋮ ⋮ \\ real [ {\sum }_{n s = 0}^{NS} {( j {ω}_{k} )}^{n s} ] - real [ {H}_{11} ( j {ω}_{k} ) {\sum }_{ds = 0}^{DS} {( j {ω}_{k} )}^{ds} ] \\ imag [ {\sum }_{n s = 0}^{NS} {( j {ω}_{k} )}^{n s} ] - imag [ {H}_{11} ( j {ω}_{k} ) {\sum }_{ds = 0}^{DS} {( j {ω}_{k} )}^{ds} ]\end{matrix} ) [ \begin{matrix}{a}_{0} \\ {a}_{1} \\ ⋮ \\ {a}_{NS} \\ {b}_{0} \\ {b}_{1} \\ ⋮ \\ {b}_{DS}\end{matrix} ] = [ \begin{matrix}0 \\ 0 \\ ⋮ \\ 0 \\ 0 \\ 0 \\ ⋮ \\ 0\end{matrix} ] \qquad ( 2 )$$

In Equation (2), each row represents a frequency sample that uses the appropriate frequency scaling to obtain a well-conditioned matrix. The interleaving of the real and imaginary part of the matrix may improve the accuracy of the solution. In addition, the real and imaginary values are separated to ensure that the coefficient vectors [a], [b] are real. Equation (2) can be rewritten in the form:

[A][x]=0 [symbol] [A]^{T}[A][x]=0 [symbol] [A]^{T}[A][x]=λₘᵢₙ[x] (3)

where

[A] contains the elements of the matrix and [x] contains the unknown coefficient vectors [a], [b]. The minimum data samples required to solve Equation (3) is (NS+DS+2). In Equation (3), the matrix is pre-multiplied with the conjugate transpose [A]^{T} and rewritten as an eigenvalue problem. The minimum eigenvalue λₘᵢₙ is computed and used to track the order of the rational function. The eigen vector [x] corresponding to λₘᵢₙ≅0 provides the coefficient vectors [a], [b]. Since the poles have to be on the left half plane for a stable solution, the right half plane poles are discarded in this step.

After computing the stable poles for a one-port macromodel, Equation (1) can be rewritten in the pole-residue form:

$$H ( s ) = {\sum }_{n = 1}^{N / 2} ( \frac{{α}_{n} + {jβ}_{n}}{s - {p}_{nr} - {jp}_{ni}} + \frac{{α}_{n} - {jβ}_{n}}{s - {p}_{nr} + {jp}_{ni}} ) + {\sum }_{m = 1}^{M} \frac{{γ}_{m}}{s - {p}_{mr}} + {k}_{D} + {k}_{L} s \qquad ( 4 )$$

where

[α]=α₁ α₂ . . . α_{N/2}]^{T}, [β]=[β₁ β₂ . . . β_{N/2}]^{T} and [γ]=[γ₁ γ₂ . . . γ_{M}]^{T} are real column vectors. N and M represent the numbers of complex conjugate and real poles, respectively. In the above equation, k_{D}≧0 represents the dc term and k_{L} is the residue of the pole at infinity. After computation of the residues [α], [β], [γ], the parameters k_{D} and k_{L} are used to minimize the error in the interpolated response. For a one-port network, Re{H(jω)}≧0∀ω is required for enforcing the passivity condition. In Equation (4), the residues are represented as αₙ+jβₙ, αₙ−jβₙ and the poles are represented as pₙᵣ+jpₙᵢ, pₙᵣ−jpₙᵢ.

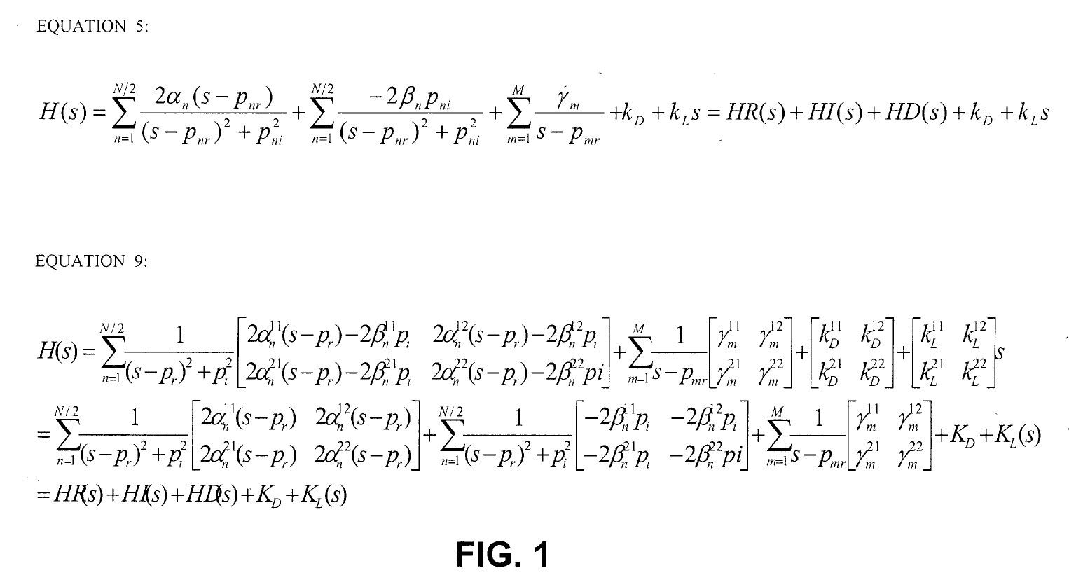

By grouping terms of Equation (4) as shown in Equation (5) (see FIG. 1), the passivity condition is met if k_{D}≧0, γₘ≧0, αₙ≧0and αₙpₙᵣ≦βₙpₘ≦−αₙpₙᵣ. In Equation (5), the function containing the sum of complex conjugate pole pairs and real poles can be regarded as the sum of passive sub-systems. If each sub-system satisfies the passivity condition, the sum of them satisfies the passivity condition as well. Note that there is no condition for k_{L}.

To calculate the residues, the coefficient [α] is calculated first by using only the real part of H(s) and solving the matrix Equation (6). Equation (6) is solved as an eigenvalue problem.

$$[ \begin{matrix}{\sum }_{n = 1}^{N / 2} \frac{- 2 {p}_{nr} ( {p}_{nr}^{2} + {p}_{ni}^{2} + {ω}_{1}^{2} )}{{( {p}_{nr}^{2} + {p}_{ni}^{2} - {ω}_{1}^{2} )}^{2} + {( 2 {p}_{nr} {ω}_{1} )}^{2}} - Re H ( j {ω}_{1} ) \\ {\sum }_{n = 1}^{N / 2} \frac{- 2 {p}_{nr} ( {p}_{nr}^{2} + {p}_{ni}^{2} + {ω}_{2}^{2} )}{{( {p}_{nr}^{2} + {p}_{ni}^{2} - {ω}_{2}^{2} )}^{2} + {( 2 {p}_{nr} {ω}_{2} )}^{2}} - Re H ( j {ω}_{2} ) \\ {\sum }_{n = 1}^{N / 2} \frac{- 2 {p}_{nr} ( {p}_{nr}^{2} + {p}_{ni}^{2} + {ω}_{k}^{2} )}{{( {p}_{nr}^{2} + {p}_{ni}^{2} - {ω}_{k}^{2} )}^{2} + {( 2 {p}_{nr} {ω}_{k} )}^{2}} - Re H ( j {ω}_{k} )\end{matrix} ] [ \begin{matrix}{α}_{1} \\ ⋮ \\ {α}_{N / 2} \\ 1\end{matrix} ] = [ \begin{matrix}0 \\ ⋮ \\ 0\end{matrix} ] \qquad ( 6 )$$

After computing αₙ and subtracting HR(s) from H(s), Equation (7) is used to compute β₂. It is important to note that the condition for βₙ is checked for each pole pair to ensure that it satisfies the condition, αₙpₙᵣ≦βₙpₘ≦−αₙpₙᵣ. If this condition is not satisfied, βₙ is set to zero to force passivity. The γₘ values are found using the same approach that was mentioned before using Image {H(s)−HR(s)−HI(s)}.

$$[ \begin{matrix}{\sum }_{n = 1}^{N / 2} \frac{- 2 {p}_{ni} ( {p}_{nr}^{2} + {p}_{ni}^{2} - {ω}_{1}^{2} )}{{( {p}_{nr}^{2} + {p}_{ni}^{2} - {ω}_{1}^{2} )}^{2} + {( 2 {p}_{nr} {ω}_{1} )}^{2}} - Re \{ H ( j {ω}_{1} ) - HR ( {jω}_{1} ) \} \\ {\sum }_{n = 1}^{N / 2} \frac{- 2 {p}_{ni} ( {p}_{nr}^{2} + {p}_{ni}^{2} - {ω}_{2}^{2} )}{{( {p}_{nr}^{2} + {p}_{ni}^{2} - {ω}_{2}^{2} )}^{2} + {( 2 {p}_{nr} {ω}_{2} )}^{2}} - Re \{ H ( j {ω}_{2} ) - HR ( {jω}_{2} ) \} \\ {\sum }_{n = 1}^{N / 2} \frac{- 2 {p}_{ni} ( {p}_{nr}^{2} + {p}_{ni}^{2} - {ω}_{k}^{2} )}{{( {p}_{nr}^{2} + {p}_{ni}^{2} - {ω}_{k}^{2} )}^{2} + {( 2 {p}_{nr} {ω}_{k} )}^{2}} - Re \{ H ( j {ω}_{k} ) - HR ( {jω}_{k} ) \}\end{matrix} ] [ \begin{matrix}{β}_{1} \\ ⋮ \\ {β}_{N / 2} \\ 1\end{matrix} ] = [ \begin{matrix}0 \\ ⋮ \\ 0\end{matrix} ] . \qquad ( 7 )$$

For a two-port network, the multi-port broadband macromodel can be represented as Equation (8). The extraction of the poles in Equation (8) is similar to the one-port network. While solving Equation (8), a common set of poles is assumed to represent the network response.

$$H ( s ) = [ \begin{matrix}{H}_{11} ( s ) & {H}_{12} ( s ) \\ {H}_{21} ( s ) & {H}_{22} ( s )\end{matrix} ] = [ \begin{matrix}\frac{{\sum }_{n s = 0}^{NS} {a}_{n s}^{11} {s}^{n s}}{{\sum }_{ds = 0}^{DS} {b}_{ds}^{11} {s}^{ds}} & \frac{{\sum }_{n s = 0}^{NS} {a}_{n s}^{12} {s}^{n s}}{{\sum }_{ds = 0}^{DS} {b}_{ds}^{12} {s}^{ds}} \\ \frac{{\sum }_{n s = 0}^{NS} {a}_{n s}^{21} {s}^{n s}}{{\sum }_{ds = 0}^{DS} {b}_{ds}^{21} {s}^{ds}} & \frac{{\sum }_{n s = 0}^{NS} {a}_{n s}^{22} {s}^{n s}}{{\sum }_{ds = 0}^{DS} {b}_{ds}^{22} {s}^{ds}}\end{matrix} ] \qquad ( 8 )$$

After the stable poles are computed, Equation (8) can be represented in the form of (9) (see FIG. 1). In equation (9), αₙ¹², βₙ¹², αₙ²¹, βₙ²¹, γₙ¹², γₙ²¹ correspond to the residue of the off-diagonal term. For Equation (9) to be passive, Re{H₁₁(jω)}≧0 and Re{H₂₂(jω)}≧0 ∀ω are required. In addition, Re{H(jω)}≧0∀ω should be positive definite that implies that the eigenvalues of Re{H(jω)} should be positive. The first condition, namely, Re{H₁₁(jω)}≧0 and Re{H₂₂(jω)}≧0 ∀ω are met by enforcing the passivity condition of one-port network described earlier. Since the determinant equals the product of the eigenvalues, Re{H(jω)} can be made positive definite if it can be shown that det{Re{H(jω)}}≧0. Since the parameters αₙ¹¹, αₙ²², βₙ¹¹, βₙ²², γₙ¹¹, γₙ²², kₙ¹¹ and kₙ²² are already known from the previous step, the coefficients αₙ¹², βₙ¹², γₙ¹² and k_{D}¹² are calculated as:

αₙ¹²≦±\sqrt{αₙ¹¹αₙ²²}

γₙ¹²≦±\sqrt{γₙ¹¹γₙ²²} (10)

k_{D}¹²≦±\sqrt{k_{D}¹¹k_{D}²²}

As described herein, the present invention provides a system and method for the construction of single-port broadband macromodels using frequency data from an electromagnetic simulation or by measurement of a device, circuit or component. This electromagnetic simulation or measurement data could represent the frequency response of a distributed interconnect system. The single-port broadband macromodels are generated using rational functions by solving an eigenvalue problem. The stability and passivity of the single-port broadband macromodels are enforced through constraints on the poles and residues of rational functions. To enable the construction of multi-port broadband macromodels having many poles, one embodiment of the present invention employs frequency slicing and sliding methods coupled with a drop-pick method, described in greater detail hereinbelow.

An example of a representative distributed system multi-port broadband macromodel is later presented to demonstrate the efficiency of the present invention when applied to simulations using such multi-port broadband macromodels. The multi-port broadband macromodels of distributed systems are passive. That is, over the entire broad band, the multi-port broadband macromodel does not generate energy. Furthermore, over the entire broadband, the multi-port broadband macromodel is stable.

For ensuring the passivity of the multi-port broadband macromodels, formulas for the passivity of multi-port broadband macromodels have been derived in accordance with the present invention from the pole-residue form of rational functions. Moreover, the three methods described herein may be used for determining hundreds of poles. The first is the frequency slicing method. The second is the frequency sliding method. The third is a drop-pick method. To enable the circuit simulation using multi-port broadband macromodels of the present invention, broadband passive macromodels are synthesized and input into a suitable circuit modeler using resistors, inductors, capacitors, and controlled sources.

A multi-port broadband macromodel determined in accordance with the present invention is determined using rational functions. The frequency response H(s) of any linear passive network can be represented as:

$$H ( s ) = \frac{{\sum }_{n s = 0}^{NS} {a}_{n s} {s}^{n s}}{{\sum }_{ds = 0}^{DS} {b}_{ds} {s}^{ds}} \qquad ( 11 )$$

where

s=jω, ω is the angular frequency in radians per second and [a]=[a₀ a₁ . . . a_{NS}]^{T} and [b]=[b₀ b₁ . . . b_{DS}]^{T} are unknown real coefficient vectors. In Equation (11), H(s) can be admittance (Y), impedance (Z), or scattering (S) parameters generated from the electromagnetic simulation or measurements. The goal of solving Equation (11) is to represent the frequency response H(s) using rational functions by computing the orders of the numerator and denominator, NS and DS, respectively, and the coefficient vectors [a] and [b].

Equation (11) can be rewritten in the pole-residue form as:

$$H ( s ) = {\sum }_{n = 1}^{CPN / 2} ( \frac{{α}_{n} + j {β}_{n}}{s - {p}_{nr} - j {p}_{ni}} + \frac{{α}_{n} + j {β}_{n}}{s - {p}_{nr} + j {p}_{ni}} ) + {\sum }_{m = 1}^{RPN} \frac{{γ}_{m}}{s - {p}_{mr}} + δ + ηs \qquad ( 12 )$$

where

pₙᵣ, pₙᵢ, pₘᵣ, αₙ, βₙ, γₘ, δ, and η are real values. In Equation (12), pₙᵣ±jpₙᵢ are the complex conjugate poles with residues αₙ±jβₙ, pₘᵣ is a real pole with a residue γₘ, δ is a residue that is independent of the frequency, and η is a residue that is linearly dependent on frequency. By combining the complex conjugate poles, Equation (12) can be rewritten as:

$$H ( s ) = {\sum }_{n = 1}^{CPN / 2} \frac{2 {α}_{n} ( s - {p}_{nr} ) - 2 {β}_{n} {p}_{ni}}{{( s - {p}_{nr} )}^{2} + {p}_{ni}^{2}} + {\sum }_{m = 1}^{RPN} \frac{{γ}_{m}}{s - {p}_{mr}} + δ + ηs \qquad ( 13 )$$

The orders CPN and RPN represent the numbers of complex conjugate poles and real poles, respectively.

Multi-port broadband macromodels constructed using Equation (11) need to satisfy the stability and passivity for a linear time-invariant passive system. Stability requires that all the poles in Equation (12) lie on the left half of the s-plane. This requirement is satisfied during the construction of macromodels by applying pₙᵣ<0 and pₘᵣ<0 in Equation (12). The passivity requires that a passive circuit does not create energy. Since non-passive macromodels combined with a stable circuit can generate an unstable time-domain response, the passivity becomes important when the macromodels need to be combined with a larger circuit for time-domain simulation. Unlike stability, it is more difficult to satisfy the passivity during the construction of conventional macromodels. With macromodels developed in accordance with the present invention, the passivity has been satisfied using the maximum modulus theorem, which states that:

Re[H(s=jω)]≧0∀ω (14)

It is important to note that s=jω in Equation (14) (and not s=σ+jω) simplifies the derivation of analytical formulas for the passivity of the multi-port broadband macromodels. The novelty behind the construction of passive macromodels for a passive system is that the sum of passive sub-networks is passive.

The rational function H(s) in Equation (13) can be regarded as a summation of sub-networks consisting of complex conjugate poles and real poles with corresponding residues, δ, and η. If every sub-networks in Equation (13) satisfies the passivity, the rational function H(s) satisfies the passivity as well. Substituting s=jω into Equation (13), the rational function H(s=jω) can be separated into the real and imaginary parts as shown in Equation (15). The real and imaginary parts are shown in Equation (16) and (17), respectively.

H(s=jω)=Hr(jω)+jHi(jω) (15)

$$\begin{matrix}Hr ( j ω ) = {\sum }_{n = 1}^{CPN / 2} \frac{2 \{ {ω}^{2} ( - {α}_{n} {p}_{nr} + {β}_{n} {p}_{ni} ) + ( {p}_{nr}^{2} + {p}_{ni}^{2} ) ( - {α}_{n} {p}_{nr} - {β}_{n} {p}_{ni} ) \}}{{( {p}_{nr}^{2} + {p}_{ni}^{2} - {ω}^{2} )}^{2} + {( 2 {p}_{nr} ω )}^{2}} + {\sum }_{m = 1}^{RPN} \frac{- {γ}_{m} {p}_{mr}}{{p}_{mr}^{2} + {ω}^{2}} + δ & ( 16 ) \\ Hi ( j ω ) = {\sum }_{n = 1}^{CPN / 2} \frac{2 ω \{ {α}_{n} ( - {p}_{nr}^{2} + {p}_{ni}^{2} - {ω}^{2} ) - 2 {β}_{n} {p}_{ni} {p}_{nr} \} - 2 {β}_{n} {p}_{ni} {p}_{nr} \}}{{( {p}_{nr}^{2} + {p}_{ni}^{2} - {ω}^{2} )}^{2} + {( 2 {p}_{nr} ω )}^{2}} + {\sum }_{m = 1}^{RPN} \frac{- {γ}_{m} ω}{{p}_{mr}^{2} + {ω}^{2}} + η ω & ( 17 )\end{matrix}$$

The passivity of each sub-network in Equation (13) is satisfied using analytical formulas for the passivity, referred to herein as “passivity formulas”, as shown in Equation (18), which is derived from the Equation (16).

−αₙpₙᵣ±βₙpₙᵢ≧0

γₘ≧0

δ≧0 (18)

Equation (13) can be generalized for a distributed multi-port network containing common poles.

$$[ H ( s ) ] = {\sum }_{n = 1}^{CPN / 2} \frac{2 [ {α}_{n} ] ( s - {p}_{nr} ) - 2 [ {β}_{n} ] {p}_{ni}}{{( s - {p}_{nr} )}^{2} + {p}_{ni}^{2}} + {\sum }_{m = 1}^{RPN} \frac{[ {γ}_{m} ]}{s - {p}_{mr}} + [ δ ] + [ η ] s \qquad ( 19 )$$

$$[ {φ}_{n} ] = [ \begin{matrix}{φ}_{n}^{11} & ⋯ & {φ}_{n}^{1 P} \\ ⋮ & ⋰ & ⋮ \\ {φ}_{n}^{P1} & ⋯ & {φ}_{n}^{PP}\end{matrix} ] \qquad ( 20 )$$

where

[φ] is a P by P matrix for a P-port network that represents the residues [α], [β], [γ], [δ], and [η]. The passivity formulas in Equation (18) for a P-port network are rewritten as:

−[αₙ]_{P×P}pₙᵣ±[βₙ]_{P×P}pₙᵢ≧[0]_{P×P} (21)

[γₘ]_{P×P}≧[0]_{P×P}

[δ]_{P×P}≧0]_{P×P}

In order to ensure the passivity for a network having a variable number (P) of ports, referred to herein as a “P-port network”, the rational function matrix [H(s)] in Equation (19) has to be a positive definite matrix. Using the property of the positive definiteness, multi-port passivity formulas from the pole-reside matrix form are:

eigenvalues of −[αₙ]_{P×P}pₙᵣ±[βₙ]_{P×P}pₙᵢ≧0 (22)

eigenvalues of [γₘ]_{P×P}≧0

eigenvalues of [δ]_{P×P}≧0

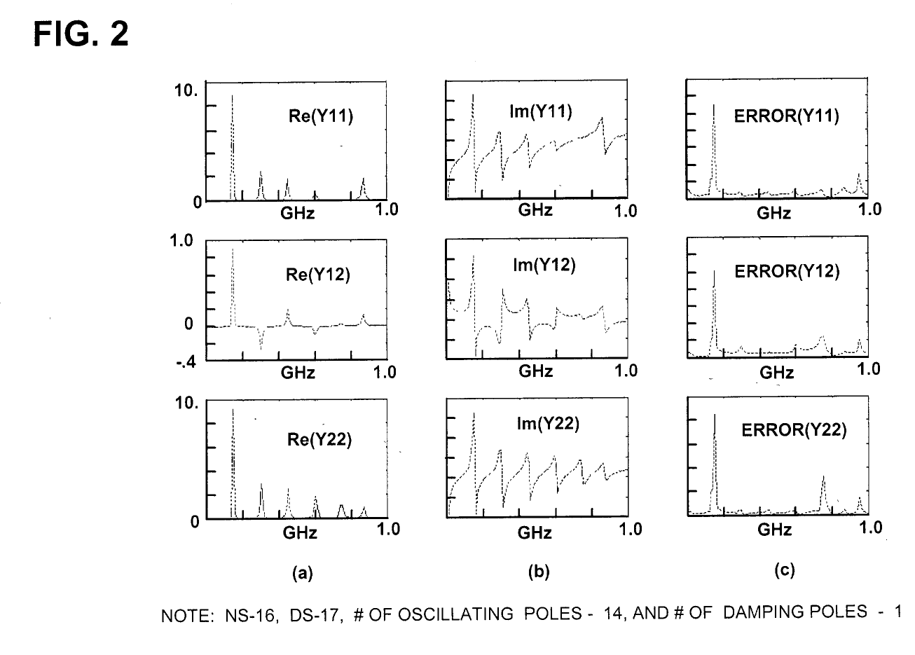

FIG. 2 is a block diagram illustrating resonance in a hypothetical power distribution system. To demonstrate the validity of the multi-port broadband macromodel determined by embodiments of the present invention, an example of a multi-port broadband macromodel developed as described herein is based upon and tested against a commonly existing component in a power distribution system. Power planes in power distribution systems exhibit resonant characteristics, as shown in FIG. 2 for the admittance parameters Y. The frequency response was modeled as a two-port network to extract the rational functions as described herein. The correlation between the original response and the developed multi-port broadband macromodel is shown on FIG. 2 over a bandwidth of 1 GHz.

In FIG. 2, the first column (a) illustrates three real (RE) components for Y11, Y12 and Y22 as determined by the macromodel in accordance with the present invention. The second column (b) illustrates three imaginary (IM) components for Y11, Y12 and Y22 as determined by the macromodel in accordance with the present invention. The third column illustrates determined errors between the macromodel simulation results and the measured response of the two-port network. The small magnitude of the errors in the third column indicates that the model developed broadband macromodel is accurate.

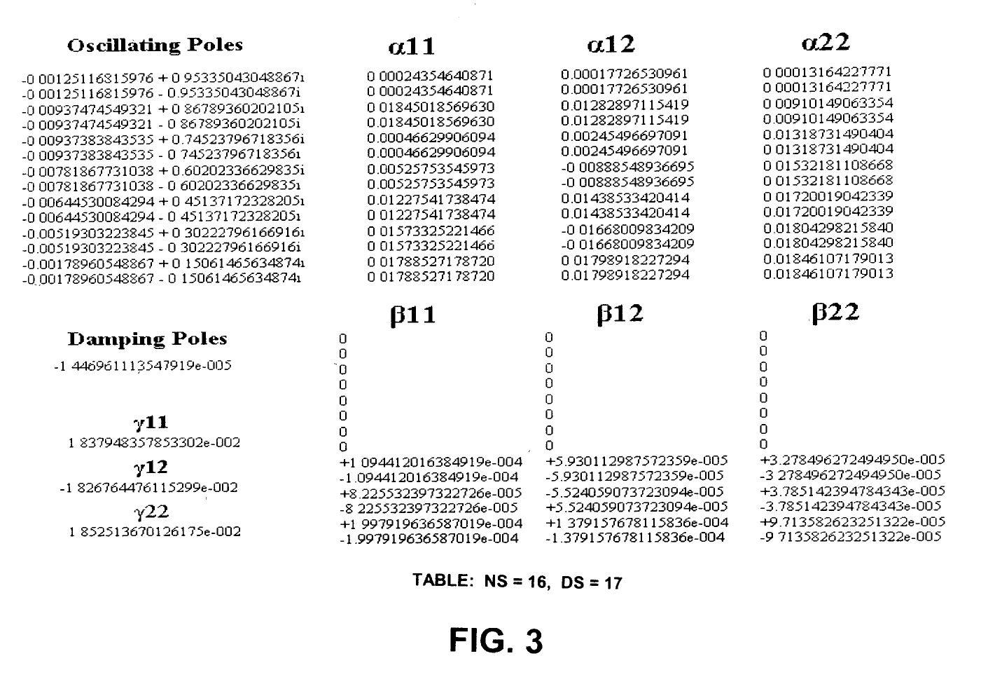

FIG. 3 is a table of extracted poles and residues of the broadband macromodel of FIG. 2. The results shown in FIG. 3 demonstrate the stability of the solution of the above-described broadband macromodel developed in accordance with the present invention.

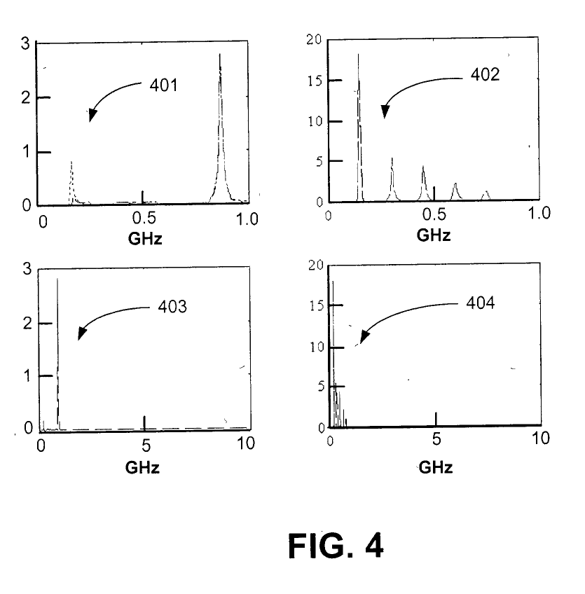

FIG. 4 are graphs of eigenvalues 401-404 extracted from the frequency response of the above-described broadband macromodel over a bandwidth of 10 giga-hertz (GHz). The 10 GHz bandwidth is ten times the bandwidth of the 1 GHz bandwidth, thereby constituting the broadband of 10 GHz. Accordingly, eigenvalue graphs 410 and 403 correspond, and eigenvalue graphs 402 and 404 correspond. The absence of negative eigenvalues from 1.0 GHz to 10 GHz demonstrates that the matrix is always positive definite.

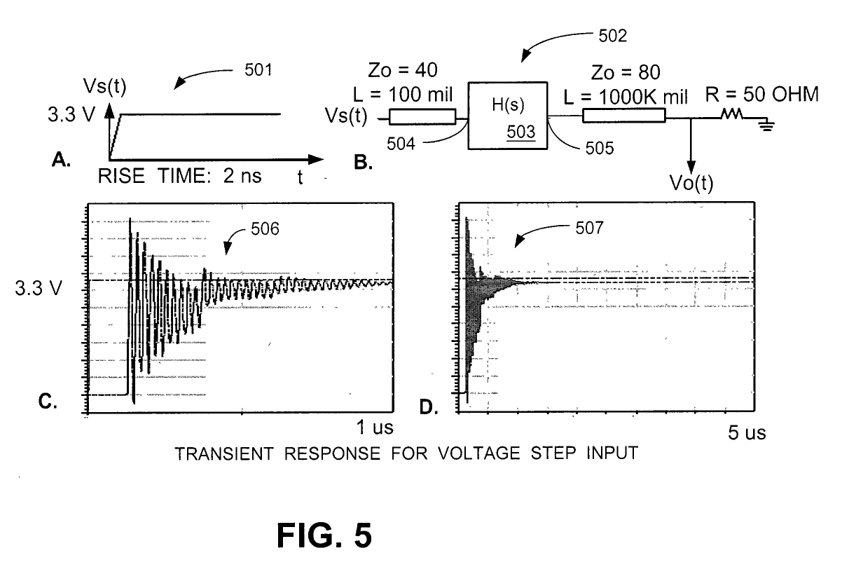

FIG. 5 illustrates the transient response for a two-port broadband macromodel having the eigenvalues of FIG. 4. FIG. 5A illustrates a 3.3 volt (V) step input 501 having a two nano-seconds (ns) rise time applied to the network 502 of FIG. 5B having the two-port broadband macromodel 503 defined by the equation H(s), according to the present invention. The two ports 504 and 505 are the input and output ports, respectively, of the H(s) macromodel 503.

In FIG. 5C, the plot 505 of the response voltage as, a function of time [V(t)] indicates transient and dynamic stability over a 1 micro-second (us) period. The plot 505 of FIG. 5D indicates no oscillatory behavior out to 5 us. Accordingly, passivity behavior of the two-port broadband macromodel is demonstrated.

To compensate negative eigenvalues, there are two free matrix variables [α] and [β] related to two free variables of complex conjugate poles, a free matrix variable [γ] related to a real pole, and a free matrix variable [δ]. In accordance with the present invention, if negative eigenvalues are present in a sub-network, negative eigenvalues are set to zero or changed to a small positive value and then a new residue matrix is reconstructed. A small positive value can be used to make sure that the macromodels do not violate passivity formulas even though this may cause small numerical errors.

The following properties from Equation (22) are apparent during the construction of passive multi-port broadband macromodels. The passivity formulas are only enforced on each sub-network of [H(s)], and there is no relationship for the passivity between sub-networks except that they contribute to the overall frequency response of macromodels. The passivity formulas that are independent of frequency and are valid up to an infinite frequency only need to be checked for ensuring the passivity. There are no constraints enforced on the residue matrix [η].

As described hereinabove, Equation (11) is solved to compute the orders, NS and DS, and the real coefficient vectors, [a] and [b]. Equation (11) can be rewritten in the form:

$${\sum }_{n s = 0}^{NS} {a}_{n s} {s}^{n s} - H ( s ) {\sum }_{ds = 0}^{DS} {b}_{ds} {s}^{ds} = 0 \qquad ( 23 )$$

For a given H(s), which represents the frequency response of a one-port network, Equation (23) can be written as a matrix equation:

[A][_{b}^{a}]=[0] [symbol] [A][x]=[0] (24)

where the matrix [A] is given by:

$$[ A ] = [ \begin{matrix}re \{ {\sum }_{n s = 0}^{NS} {( j {ω}_{i} )}^{n s} \} - re \{ H ( j {ω}_{i} ) {\sum }_{ds = 0}^{DS} {( {jω}_{i} )}^{ds} \} \\ i m \{ {\sum }_{n s = 0}^{NS} {( j {ω}_{i} )}^{n s} \} - im \{ H ( j {ω}_{i} ) {\sum }_{ds = 0}^{DS} {( {jω}_{i} )}^{ds} \} \\ re \{ {\sum }_{n s = 0}^{NS} {( j {ω}_{k} )}^{n s} \} - re \{ H ( j {ω}_{k} ) {\sum }_{ds = 0}^{DS} {( {jω}_{k} )}^{ds} \} \\ im \{ {\sum }_{n s = 0}^{NS} {( j {ω}_{k} )}^{n s} \} - im \{ H ( j {ω}_{k} ) {\sum }_{ds = 0}^{DS} {( {jω}_{k} )}^{ds} \}\end{matrix} ] \qquad ( 25 )$$

The vectors [a] and [b] in Equation (24) are real coefficient vectors of the numerator and denominator, respectively. After pre-multiplying Equation (25) with the transpose of [A], Equation (24) becomes:

[A]^{T}[A][x]=[0] (26)

which can be written as an eigenvalue equation:

[A]^{T}[A][x]=λₘᵢₙ[x] (27)

where

λₘᵢₙ is the minimum eigenvalue of the matrix [A]^{T}[A]. From Equation (27), the computation of the real coefficient vector [x] requires the estimation of the integer order NS and DS. Once the orders NS and DS are determined, the vector [x] is the eigen vector corresponding to the minimum eigenvalue.

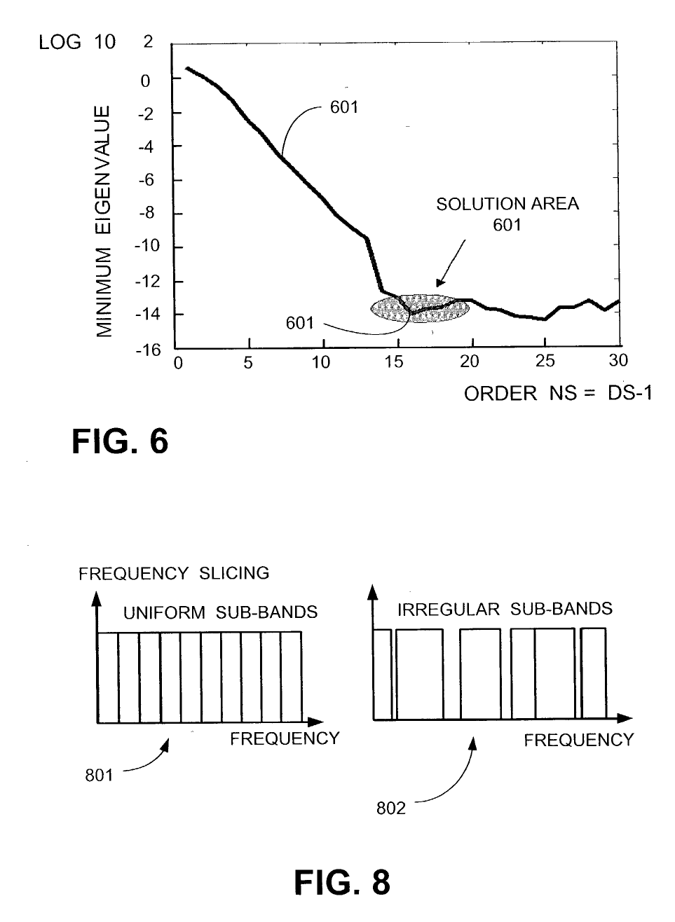

FIG. 6 is a graph 601 illustrating a minimum eigenvalue 602 in a solution area 603. Using DS=NS+1, the eigen vector [x] is computed by tracking the minimum eigenvalue 602 by changing the numerator order NS. In FIG. 6, the solution area 603 can represent the region with a valid solution, which corresponds to λₘᵢₙ≈10⁻¹⁴. For this eigenvalue, the estimated orders NS=16, DS=17 and the eigen vector [x] corresponding to the minimum eigenvalue 602 can be obtained.

The stability now may be enforced on the denominator coefficient vector [b] of the eigen vector [x] in Equation (27) by applying pₙᵣ<0 and pₘᵣ<0. This may be done by using a suitable root finding algorithm to compute the poles and discarding the unstable poles. For computing the residues corresponding to the stable poles, Equation (28) is solved using the eigenvalue method discussed earlier. For a multi-port network containing common poles, the residues for each port are constructed independently by solving Equation (28).

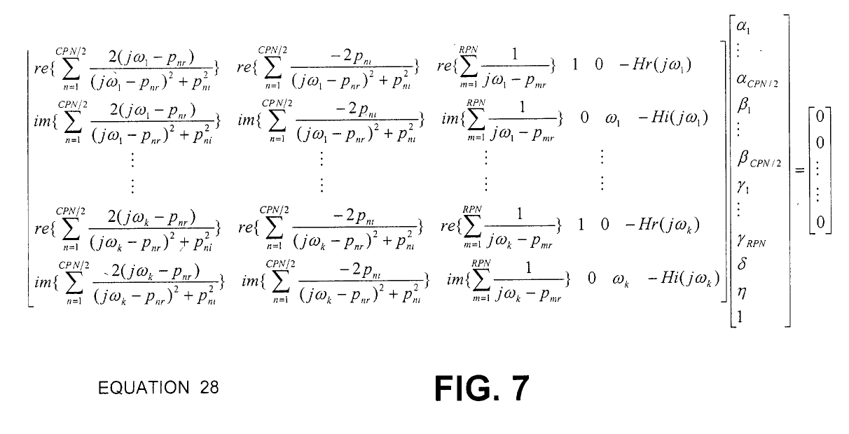

Realistic distributed networks such as interconnects operating over a broad frequency range often contain hundreds of poles and residues and the amplitude variation of the frequency response could be large. This can create numerical problems since the matrix [A]^{T}[A] in Equation (27) can become an ill-conditioned matrix. This is apparent in Equation (11), where the power series expansion in the numerator and denominator can have a large dynamic range. This problem can be improved using a frequency scaling and the computed poles and residues can be reconstructed using the scaling factor ω₀. Equation (23) is converted into the form of Equation (28) (see FIG. 7).

$${\sum }_{n s = 0}^{NS} {{a}_{n s} ( \frac{s}{{ω}_{0}} )}^{n s} - H ( s ) {\sum }_{ds = 0}^{DS} {{d}_{ds} ( \frac{s}{{ω}_{0}} )}^{ds} = 0 \qquad ( 29 )$$

However, the scaling factor in Equation (29) to approximate the frequency response does not result in any improvement in the approximation beyond 20-30 poles. Hence, earlier solutions have used the Chebyshev polynomial expansion to approximate the frequency response using the orthogonal property of Chebyshev polynomials. However, it is important to note that the power series expansion with a frequency scaling is comparable to the Chebyshev polynomial expansion for low-order systems. In addition, a major problem with the Chebyshev polynomial expansion is that it needs to be finally converted into the pole-residue representation for implementation. In accordance with embodiments of the present invention, frequency slicing and sliding methods coupled with a drop-pick method using a relevant frequency scaling avoids the above-described ill-conditioned matrix problem that is not resolved by the Chebyshev polynomial expansion.

The rational function matrix [H(s)] is expanded in the pole-residue form as a summation of sub-networks. Both the stability and passivity in each sub-network are satisfied. In accordance with the present invention, two terms are defined:

1) frequency slicing, which divides the computational domain (the frequency region of interest) into smaller sub-computational domains (referred to hereinafter as sub-bands), and

2) frequency sliding, which enables the movement of the sub-computational domain within the computational domain.

Embodiments of the present invention provide for the construction of multi-port broadband macromodels valid over large computational domains so that complex conjugate poles and real poles can be extracted from a localized region of the frequency response in a sub-computational domain. Accordingly, the original frequency response is divided into sub-computational domains, or sub-bands, where local poles for each sub-band are extracted. It is important to note that since passivity formulas are only enforced on each sub-network, the present invention enables the overall frequency response to be divided into sub-bands.

FIG. 8 illustrates the construction of a plurality of sub-bands. The sub-bands 801can be uniform in width (uniform frequency range), or the sub-bands 802 may be irregular (non-uniform frequency ranges). The size, width and number of sub-bands will depend on the particular application in which the present invention is used. As one sub-band is analyzed to determine poles, the sub-computational domains values are changed (referred to a “sliding” herein) so that other sub-computational domains are analyzed.

Multi-port broadband macromodels having hundreds of poles and residues can efficiently be constructed after 1) calculating sub-band macromodels from one of sub-bands, 2) moving to another sub-band, which is the frequency sliding method, and subtracting previous sub-band macromodels from the frequency response, 3) repeat (1) and (2) until the end of the sub-bands, 4) and then finally collecting all sub-band macromodels from each sub-computational domain.

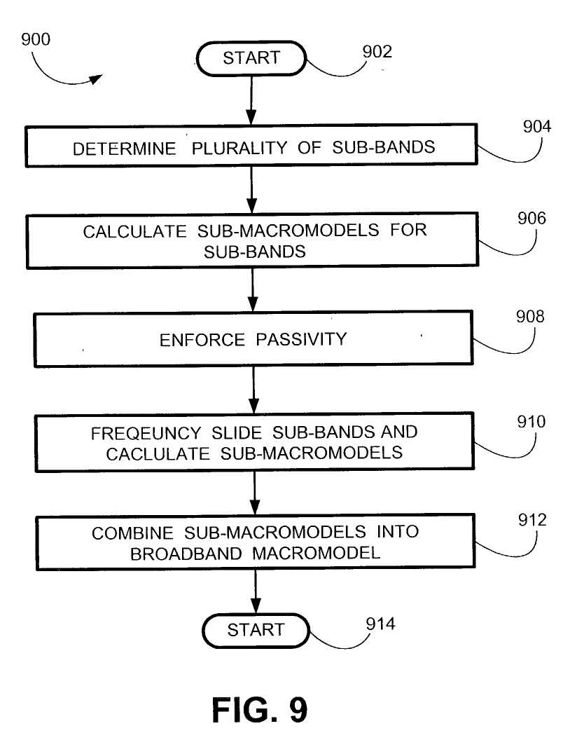

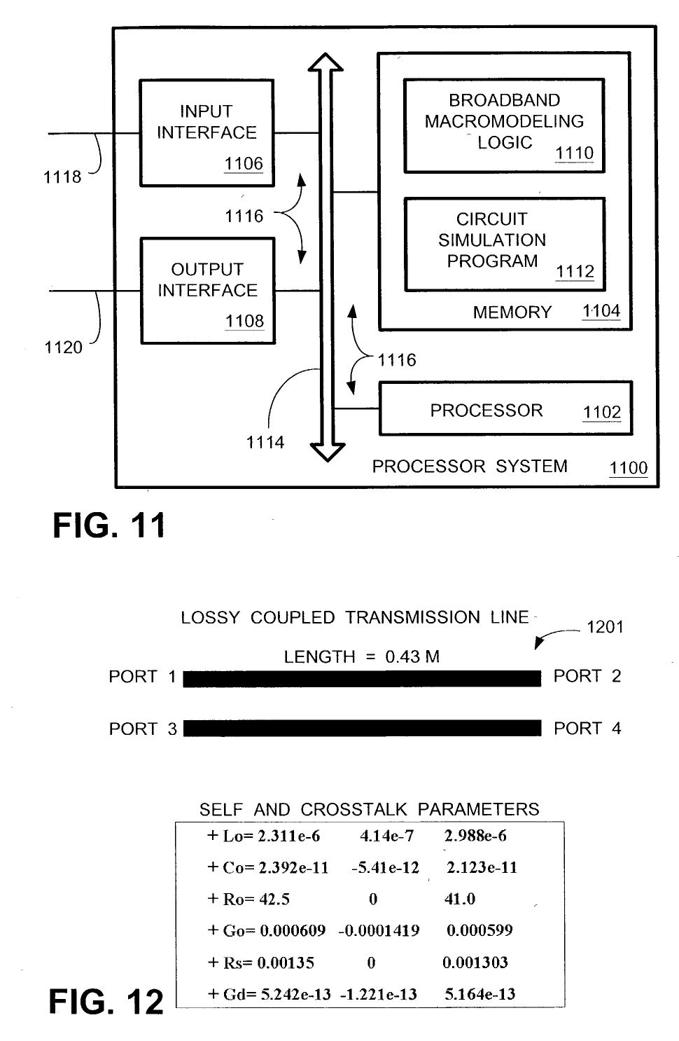

FIG. 9 is a is a flow chart illustrating the frequency slicing and frequency sliding methods of constructing a multi-port broadband macromodel in accordance with the present invention. The flow chart 900 shows the architecture, functionality, and operation of a possible implementation of the software implementing the broadband macromodeling logic 1110 (FIG. 11). In this regard, each block may represent a module, segment, or portion of code, which comprises one or more executable instructions for implementing the specified logical function(s). It should also be noted that in some alternative implementations, the functions noted in the blocks may occur out of the order noted in FIG. 9 or may include additional functions without departing significantly from the functionality of the present invention. For example, two blocks shown in succession in FIG. 9 may in fact be executed substantially concurrently, the blocks may sometimes be executed in the reverse order, or some of the blocks may not be executed in all instances, depending upon the functionality involved, as will be further clarified hereinbelow. All such modifications and variations are intended to be included herein within the scope of this disclosure for the present invention.

The process starts at block 902. At block 904, a plurality of sub-bands are defined for the broadband frequency spectrum. As described herein, sub-bands may be evenly sized or irregularly sized depending upon the particular modeling needs. At block 906, sub-band macromodels are defined for each of the sub-bands. In accordance with the present invention, passivity is enforced at block 908.

At block 910, the sub-bands are adjusted (frequency sliding) and sub-band macromodels are determined for the new sub-bands (as described above for blocks 906 and 908). At block 912, the determined sub-band macromodels are combined to determine a broadband macromodel. The process ends at block 914.

It is important to note that the determined sub-band macromodels using the frequency slicing and sliding methods, and the frequency scaling, can be constructed without having an ill-conditioned matrix problem since it deals with a lower-order system. In addition, since the number of required poles is reduced and the orders NS and DS become small in a sub-band, the size of the matrix [A]^{T}[A] becomes small and the required computational memory and CPU time can be reduced.

Though the frequency slicing method divides the computational domain into sub-bands and enables the extraction of local poles and/or residues within a sub-band, frequency slicing may miss the poles at the boundary between the sub-bands or have spurious poles within the sub-band. Furthermore, poles in adjacent sub-bands may interact with poles in the current sub-band, thereby inducing greater distortion in the determined poles.

The embodiment further employs a drop-pick method (described below) to improve the accuracy of constructed macromodels. The poles of the computed sub-bands are constructed together (combined) over the broadband frequency. The data reconstructed from the macromodels is compared against the frequency data generated from measurements or electromagnetic simulation. Errors in one or more poles are identified during the comparison. The comparison may be performed visually or computationally. Poles suspected of being erroneous are identified by magnitude or frequency location. For each suspected erroneous pole identified, a new sub-band around that pole is defined, and the poles for the sub-band are recalculated. Thus, erroneous poles are “dropped” and new poles (presumably more accurate) are determined from a new “picked” sub-band. Hence the term “drop-pick” method as used herein.

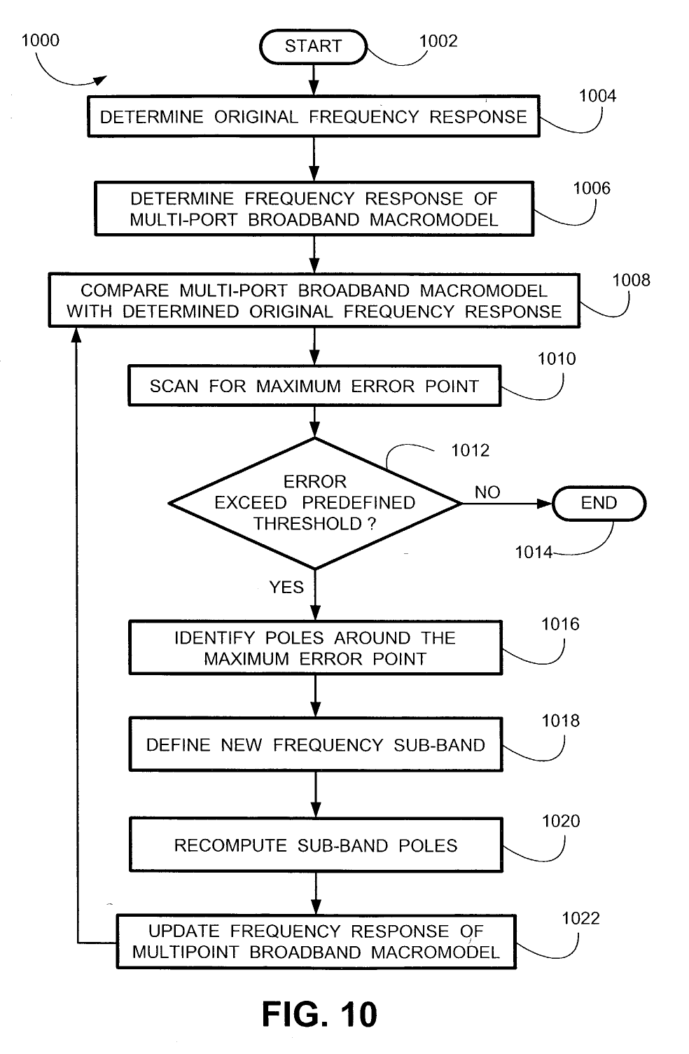

FIG. 10 is a is a flow chart illustrating the drop-pick method of constructing an improved accuracy multi-port broadband macromodel in accordance with the present invention. The flow chart 1000 shows the architecture, functionality, and operation of a possible implementation of the software for implementing the broadband macromodeling logic 1110 (FIG. 11). In this regard, each block may represent a module, segment, or portion of code, which comprises one or more executable instructions for implementing the specified logical function(s). It should also be noted that in some alternative implementations, the functions noted in the blocks may occur out of the order noted in FIG. 10 or may include additional functions without departing significantly from the functionality of the present invention. For example, two blocks shown in succession in FIG. 10 may in fact be executed substantially concurrently, the blocks may sometimes be executed in the reverse order, or some of the blocks may not be executed in all instances, depending upon the functionality involved, as will be further clarified hereinbelow. All such modifications and variations are intended to be included herein within the scope of this disclosure for the present invention.

The process starts at block 1002. Accordingly, the first multi-port broadband macromodel has been determined in accordance with the present invention. Also, the measured or electromagnetic simulation data has already been collected.

At block 1004, the original frequency response [Ho(s)] is determined. As described above, the original frequency response is generated from measurements or electromagnetic simulation. At block 1006, the frequency response of the multi-port broadband macromodel [Hm(s)] is determined by embodiments of the present invention described herein.

At block 1008, the determined original frequency response [Ho(s)] is compared with the determined frequency response of the multi-port broadband macromodel [Hm(s)] determined by embodiments of the present invention. At block 1010, the maximum error location, Lmo, is scanned for. Errors may be defined by differences in the magnitude (Emo) of a pole (or eigenvalue), and/or by differences in frequency location (Lmo) of a pole (or eigenvalue). Accordingly, the error location indicates the frequency (or frequency region) where a computed pole (or eigenvalue) does not correlate with a pole (or eigenvalue) determined for the original data. At block 1012, a determination is made whether the difference (error) between the poles at/near the maximum error location Lmo exceeds a predefined threshold.

If not (the NO condition), the process proceeds to block 1014 and ends. That is, there the frequency response of the multi-port broadband macromodel is sufficiently accurate for modeling purposes.

However, if at block 1012 the maximum error location Lmo are exceeds the predefined threshold (the YES condition), the process proceeds to block 1016. At block 1016, poles around the maximum error location Lmo are searched for. At block 1018 a new sub-band is defined. A new sub-band is defined to include a suitable number of poles. For example, one embodiment includes five poles in the new sub-band.

At block 1020, poles and residuals of the sub-band are recomputed. At block 1022, the new poles (and residuals) are used to update the frequency response of the multi-port broadband macromodel. The process returns to block 1008 so that the reconstructed frequency response of the multi-port broadband macromodel is compared with the original frequency response.

Thus, the process begins with comparing the frequency response [Hm(s)] generated from the macromodels and the original frequency response [Ho(s)] over the computational domain. Based on the error criterion, the maximum difference value Emo and location Lmo between [Hm(s)] and [Ho(s)] is determined. A new sub-band is selected based on the location of the Lmo. If Eno<Emo, the erroneous poles are replaced with new poles by dropping and picking these poles, which is called as the drop-pick method. The above-described process continues in an iterative fashion until a good match is achieved. After the poles and residues in the entire frequency domain or sub-domains are constructed, the constants δ and η can be calculated.

Using the pole-residue representation of the rational function representing the admittance parameters, electrical networks consisting of resistors, inductors, capacitors, and controlled sources can be constructed.

FIG. 11 is a block diagram illustrating an embodiment of the present invention implemented as a processor system 1100. Processor system comprises a processor 1102, a memory 1104, an input interface 1106 and an output interface 1108. Memory 1104 further includes the broadband modeling logic 1110 and may optionally include a circuit simulation program 1112. The processor 1102, memory 1104, input interface 1106 and output interface 1108 are communicatively coupled to each other through bus 1114, via connections 1116.

Input interface 1106 is configured to receive operating instructions and input data, via connection 1118. Accordingly, input interface 1106 is in communication with one or more devices such as, but not limited to, another processor, a remote memory device, a keyboard device, or the like. Output interface 1108 is configured to communicate output data, via connection 1120. Accordingly, output interface 1108 is in communication with one or more devices such as, but not limited to, another processor, a remote memory device, a display device, a printing device or the like.

In accordance with the present invention, data corresponding to the original frequency response, generated from measurements or electromagnetic simulation, is received by the input interface 1106, in addition to any required processing instructions. Processor 1102 retrieves and executes the broadband macromodeling logic 1110. In accordance with the present invention, a broadband macromodel is determined that is stable and that exhibits passivity.

In one embodiment, the circuit simulation program 1112 is retrieved and executed using the determined broadband macromodel. In another embodiment, data corresponding to the determined broadband macromodel is output through the output interface 1108 for use in a remote circuit simulation program. In some embodiments, reports corresponding to the determined broadband macromodel, such as data and frequency response information, is output through the output interface 1108.

In an alternative embodiment, the broadband macromodeling logic 1110 is implemented as a stand-alone program that interfaces with the circuit simulation program 1112. In another embodiment, the broadband macromodeling logic 1110 is implemented as an internal component or routine within the circuit simulation program 1112. Yet another embodiment is implemented as a remote circuit simulation program that is configured to receive and apply broadband macromodels and data determined in accordance with the present invention.

FIG. 12 illustrates an exemplary transmission line 1201. Self and crosstalk parameters values are as noted in FIG. 12. The first exemplary multi-port broadband macromodel case is based upon the transmission line 1201, which is a four-port lossy coupled transmission line.

An exemplary four-port (multi-port) broadband macromodel was determined in accordance with the present invention. A simulation was determined over a frequency range of 10 GHz using the above-described methods of FIGS. 9 and 10. Original frequency response data was also obtained using conventional techniques.

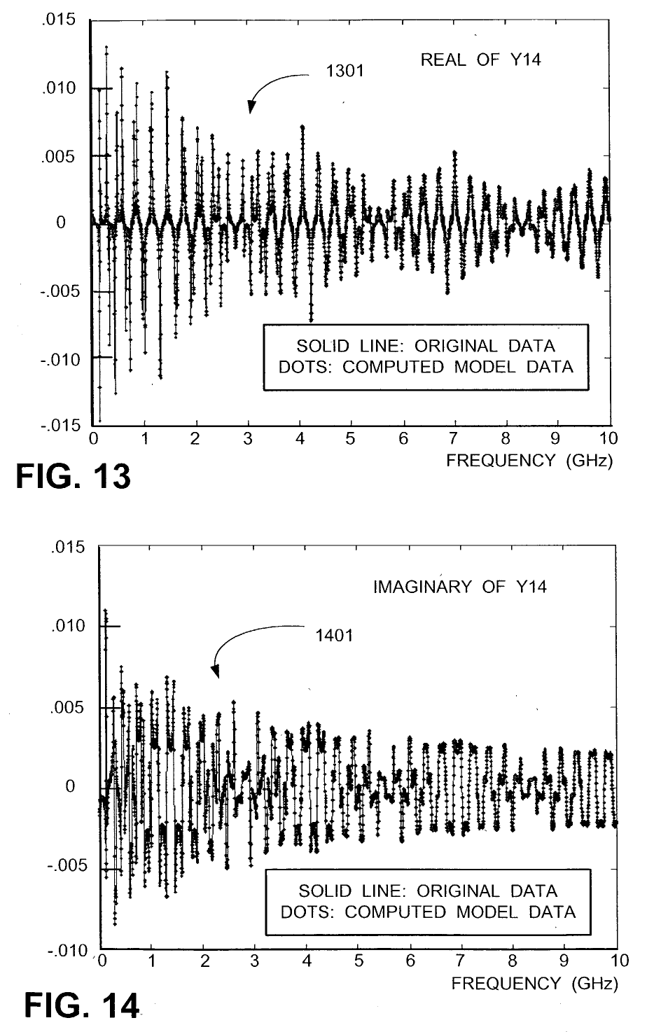

FIGS. 13 and 14 are comparison plots 1301 and 1401 between the original frequency response data and constructed macromodels for Y14 admittance parameters, real and imaginary, respectively, over 10 GHz bandwidth. The solid line on the plots 1301 and 1401 correspond to the original frequency response data, generated from measurements or electromagnetic simulation. The dots on the plots 1301 and 1401 correspond to computed points based upon the constructed macromodels. The number of complex conjugate poles and real poles extracted were 240 and 3, respectively, using the estimated order NS=4 and irregular sub-bands having a roughly 122 MHz band. FIGS. 13 and 14 illustrate the correlation between the poles, and their peak magnitudes, for the original data and the exemplary multi-port broadband macromodel.

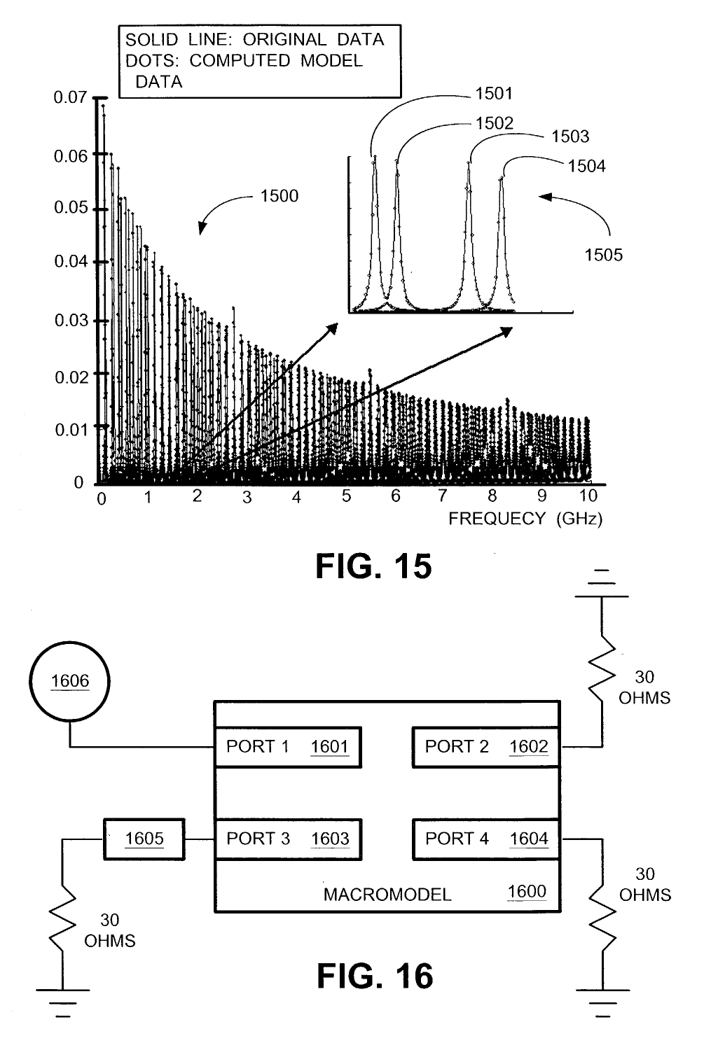

FIG. 15 is a plot of eigenvalues 1500 for the original frequency response data and constructed multi-port broadband macromodels. Passivity is enforced by setting negative eigenvalues to zero or a suitable positive value when the multi-port broadband macromodels are constructed. To further demonstrate the passivity of the macromodels in the frequency-domain, the four eigenvalues 1501-1504 for a selected frequency band 1505 are shown in FIG. 15. These four eigenvalues 1501-1504 are greater than zero.

FIG. 16 is a block diagram of a broadband macromodel 1600 of the transmission line of FIG. 12. The broadband macromodel 1600 was synthesized without enforcing passivity according to the present invention. The broadband macromodel 1600 comprises four ports, 1601-1604. Thirty ohm termination impedances were employed to terminate ports 1602-1604. Component T3, denoted with reference numeral 1605, is coupled between the termination resistor and port 1603. Thus, port 1603 is terminated with a 30 ohm and a transmission line having a 50 ohm characteristic impedance and 1.2 ns delay in series.

Current generator 1606 injects current into the broadband macromodel 1600. In a simulated case, current generator 1606 provides a trapezoidal current source with 0.1 ns rising and 0.2 ns falling times.

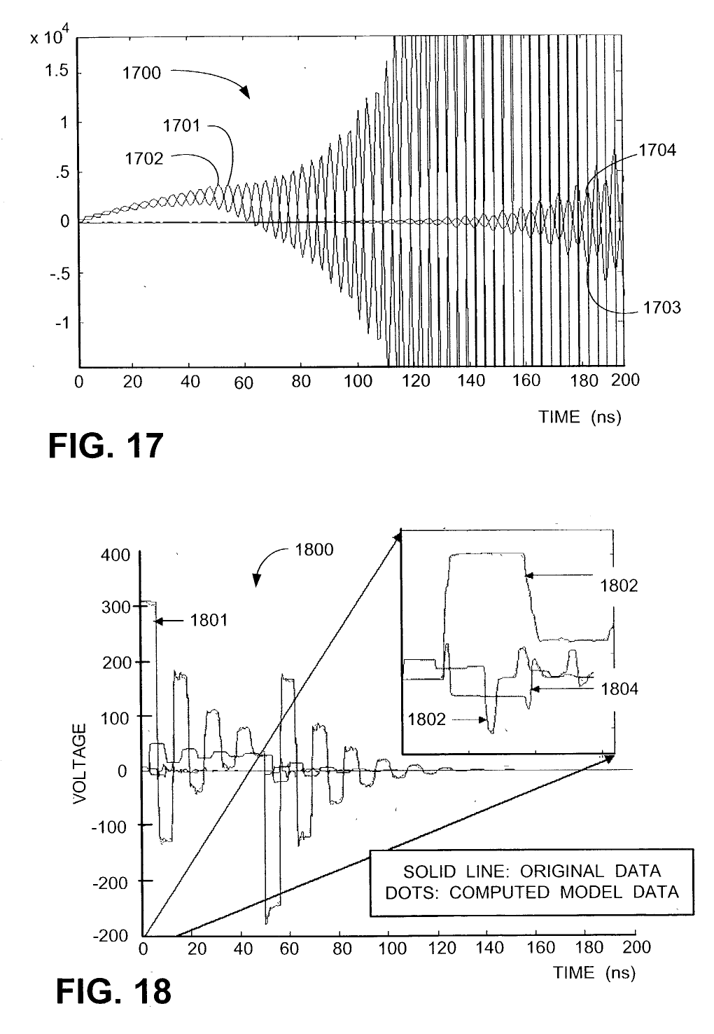

FIG. 17 is a time-domain plot 1700 for the broadband macromodel 1600 (FIG. 16) when passivity is not enforced in accordance with the present invention. The four plots 1701-1704 are simulated output of the ports 1601-1604, respectively. Because passivity was not enforced, the broadband macromodel 1600 violated the passivity requirement for a valid multi-port broadband macromodel, as demonstrated by the diverging results in time-domain simulation.

FIG. 18 is a time-domain plot 1800 for the broadband macromodel 1600 (FIG. 16) when passivity is enforced in accordance with the present invention. Using a passive multi-port broadband macromodel, the four plots 1801-1804, corresponding to ports 1601-1604 (FIG. 16), respectively, indicate stable and non-passive performance over the 200 ns time period. Furthermore, the plots 1801-1804 correspond with measured data from the original network upon which the multi-port broadband macromodel was based upon.

It should be emphasized that the above-described embodiments of the present invention, particularly, any “preferred” embodiments, are merely possible examples of implementations, merely set forth for a clear understanding of the principles of the invention. Many variations and modifications may be made to the above-described embodiment(s) of the invention without departing substantially from the spirit and principles of the invention. All such modifications and variations are intended to be included herein within the scope of this disclosure and the present invention and protected by the following claims.

What is claimed is:

1. A method that that provides a model that simulates response of a multi-port passive circuit over a broadband frequency range, the method comprising:
determining a plurality parameters of the model corresponding to the multi-port passive circuit;
determining a plurality of pole-residue-eigenvalues associated with the determined parameters;
identifying at least one pole-residue-eigenvalue having a magnitude less than zero;
changing a value of the at least one identified pole-residue-eigenvalue; and
recalculating at least one of the parameters after the setting the identified pole-residue-eigenvalue to at least zero.

2. The method of claim 1, wherein at least one of the plurality of parameters is a pole.

3. The method of claim 1, wherein at least one of the plurality of parameters is a residue.

4. The method of claim 1, wherein changing the value further comprises setting the at least one identified pole-residue-eigenvalue to zero.

5. The method of claim 1, wherein changing the value further comprises setting the at least one identified pole-residue-eigenvalue to a positive value.

6. The method of claim 1, further comprising adding the model into a circuit simulation program.

7. The method of claim 1, further comprising adding the recalculated parameter into a corresponding model residing in a circuit simulation program

8. The method of claim 1, further comprising changing a selected residue to zero for negative pole-residue-eigenvalue for a single-port broadband macromodel.

9. The method of claim 1, further comprising changing a selected residue to zero for negative pole-residue-eigenvalues for a two-port broadband macromodel.

10. The method of claim 1, wherein determining the plurality of pole-residue-eigenvalues further comprising:
frequency slicing the broadband frequency range into a plurality of sub-bands; and
determining a plurality of sub-band pole-residue-eigenvalues for each sub-band.

11. The method of claim 10, further comprising changing a value of at least one of the plurality of sub-band pole-residue-eigenvalues to zero when the sub-band pole-residue eigenvalue has a magnitude less than zero.

12. The method of claim 10, further comprising changing a value of at least one of the plurality of sub-band pole-residue-eigenvalues to a positive value when the new pole-residue-eigenvalue has a magnitude less than zero.

13. The method of claim 10, further comprising assembling the plurality of sub-band pole-residue-eigenvalues determined for each of the sub-bands.

14. The method of claim 10, further comprising calculating a sub-band macromodel for each of the plurality of sub-bands from the determined sub-band pole-residue-eigenvalues of the corresponding sub-band.

15. The method of claim 14, further comprising combining the sub-band macromodels calculated for each of the plurality of sub-bands into a multi-port broadband macromodel.

16. The method of claim 15, further comprising:
sliding each one of the sub-bands so that a frequency range of the sub-band changes;
determining a second plurality of sub-band pole-residue-eigenvalues for each sub-band;
assembling the second plurality of sub-band pole-residue-eigenvalues with the plurality of sub-band pole-residue-eigenvalues; and
recalculating the sub-band macromodel for each of the plurality of sub-bands.

17. The method of claim 15, further comprising:
obtaining a frequency response of the multi-port passive circuit;
determining a plurality of original data-eigenvalues from the obtained frequency response of the multi-port passive circuit;
obtaining a macromodel frequency response of the multi-port broadband macromodel;
determining a plurality of macromodel data-eigenvalues from the obtained frequency response of the multi-port broadband macromodel; and
comparing the determined plurality of original data-eigenvalues with the plurality of macromodel data-eigenvalues.

18. The method of claim 17, wherein obtaining the frequency response of the multi-port passive circuit further comprises obtaining the frequency response by electromagnetic simulation.

19. The method of claim 17, wherein obtaining the frequency response of the multi-port passive circuit further comprises obtaining the frequency response by measurement.

20. The method of claim 17, further comprising:
identifying a difference between at least one original data-eigenvalue and a corresponding macromodel data-eigenvalue; and
re-determining the macromodel data-eigenvalue when the difference exceeds a predefined threshold.

21. The method of claim 20, wherein identifying the difference further comprises determining a difference in a magnitude of the original data-eigenvalue and a magnitude of the corresponding macromodel data-eigenvalue.

22. The method of claim 20, wherein identifying the difference further comprises determining a difference in a frequency location of the original data-eigenvalue and a frequency location of the corresponding macromodel data-eigenvalue.

23. The method of claim 20, wherein re-determining the macromodel data-eigenvalue further comprises:
identifying an error location, the error location corresponding to a frequency of the identified macromodel data-eigenvalue;
determining an error sub-band, the error sub-band having a frequency range around the error location;
determining a plurality of new poles and residues for the error sub-band; and
replacing corresponding macromodel poles and residues with the determined new poles and residues.

24. The method of claim 23, further comprising:
determining a plurality of new pole-residue-eignevalues from a compensated macromodel having the determined new poles and residues; and
changing a value of at least one of the plurality of new pole-residue-eigenvalues for the error sub-band to zero when the new pole-residue-eigenvalue has a magnitude less than zero.

25. The method of claim 23, further comprising:
determining a plurality of new pole-residue-eignevalues from a compensated macromodel having the determined new poles and residues; and
changing a value of at least one of the plurality of new pole-residue-eigenvalues for the error sub-band to a positive value when the new pole-residue-eigenvalue has a magnitude less than zero.

26. A system for simulating response of a multi-port passive circuit over a broadband frequency range, comprising:
means for determining a plurality of parameters of a model corresponding to the passive circuit;
means for determining a plurality of pole-residue-eigenvalues associated with the determined parameters;
means for identifying at least one pole-residue-eigenvalue having a magnitude less than zero;
means for changing a value of the at least one identified pole-residue-eigenvalue to zero; and
means for recalculating at least one of the parameters after the setting the at least one identified pole-residue-eigenvalue to at least zero.

27. The system of claim 26, wherein at least one of the plurality of parameters is a pole.

28. The system of claim 26, wherein at least one of the plurality of parameters is a residue.

29. The system of claim 26, wherein the means for changing the value further comprises means for setting the at least one identified pole-residue-eigenvalue to zero.

30. The system of claim 26, wherein the means for changing the value further comprises means for setting the at least one identified pole-residue-eigenvalue to a positive value.

31. The system of claim 26, further comprising means for adding the model into a circuit simulation program.

32. The system of claim 26, further comprising:
means for frequency slicing the broadband frequency range into a plurality of sub-bands;
means for determining a plurality of sub-band pole-residue-eigenvalues for each sub-band;
means for changing a value of at least one of the plurality of sub-band pole-residue-eigenvalues to zero when the sub-band pole-residue-eigenvalue has a magnitude less than zero;
means for assembling the plurality of sub-band pole-residue-eigenvalues determined for each of the sub-bands;
means for calculating a sub-band macromodel for each of the plurality of sub-bands from the determined sub-band pole-residue-eigenvalues of the corresponding sub-band; and
means for combining the sub-band macromodels calculated for each of the plurality of sub-bands into a multi-port broadband macromodel.

33. The system of claim 32, further comprising:
means for sliding each one of the sub-bands so that a frequency range of the sub-band changes;
means for determining a second plurality of sub-band pole-residue-eigenvalues for each sub-band;
means for assembling the second plurality of sub-band pole-residue-eigenvalues with the plurality of sub-band pole-residue-eigenvalues; and
means for recalculating the sub-band macromodel for each of the plurality of sub-bands.

34. The system of claim 32, further comprising:
means for obtaining a frequency response of the multi-port passive circuit;
means for determining a plurality of original data-eigenvalues from the obtained frequency response of the multi-port passive circuit;
means for obtaining a macromodel frequency response of the multi-port broadband macromodel;
means for determining a plurality of macromodel data-eigenvalues from the obtained frequency response of the multi-port broadband macromodel; and
means for comparing the determined plurality of original data-eigenvalues with the plurality of macromodel data-eigenvalues.

35. The system of claim 34, further comprising:
means for identifying a difference between at least one original data-eigenvalue and a corresponding macromodel data-eigenvalue; and
means for re-determining the macromodel data-eigenvalue when the difference exceeds a predefined threshold.

36. The system of claim 35, wherein the means for identifying the difference further comprises means for determining a difference in a magnitude of the original data-eigenvalue and a magnitude of the corresponding macromodel data-eigenvalue.

37. The system of claim 35, wherein the means for identifying the difference further comprises means for determining a difference in a frequency location of the original data-eigenvalue and the frequency location of the corresponding macromodel data-eigenvalue.

38. The system of claim 35, wherein the means for re-determining the macromodel data-eigenvalue further comprises:
means for identifying an error location, the error location corresponding to a frequency of the identified macromodel data-eigenvalue;
means for determining an error sub-band, the error sub-band having a frequency range around the error location;
means for determining a plurality of new poles and residues for the error sub-band; and
means for replacing corresponding macromodel poles and residues with the determined new poles and residues.

39. A computer-readable medium having a program for simulating a response of a multi-port passive circuit over a broadband frequency range, the program comprising logic configured to perform the steps of:
determining a plurality of parameters of a model corresponding to the passive circuit;
determining a plurality of pole-residue-eigenvalues associated with the determined parameters;
identifying at least one pole-residue-eigenvalue having a magnitude less than zero;
changing a value of at least one identified pole-residue-eigenvalue to zero; and
recalculating at least one of the parameters after the setting the at least one identified pole-residue-eigenvalue to at least zero.

40. The program of claim 39, wherein at least one of the plurality of parameters is a pole.

41. The program of claim 39, wherein at least one of the plurality of parameters is a residue.

42. The program of claim 39, wherein changing the value further comprises setting the at least one identified pole-residue-eigenvalue to zero.

43. The program of claim 39, wherein changing the value further comprises setting the at least one identified pole-residue-eigenvalue to a positive value.

44. The program of claim 39, further comprising adding the model into a circuit simulation program.

45. The program of claim 39, further comprising:
frequency slicing the broadband frequency range into a plurality of sub-bands;
determining a plurality of sub-band pole-residue-eigenvalues for each sub-band;
changing a value of at least one of the plurality of sub-band pole-residue-eigenvalues to zero when the sub-band pole-residue-eigenvalue has a magnitude less than zero;
assembling the plurality of sub-band pole-residue-eigenvalues determined for each of the sub-bands;
calculating a sub-band macromodel for each of the plurality of sub-bands from the determined sub-band pole-residue-eigenvalues of the corresponding sub-band; and
combining the sub-band macromodels calculated for each of the plurality of sub-bands into a multi-port broadband macromodel.

46. The program of claim 45, further comprising:
sliding each one of the sub-bands so that a frequency range of the sub-band changes;
determining a second plurality of sub-band pole-residue-eigenvalues for each sub-band;
assembling the second plurality of sub-band pole-residue-eigenvalues with the plurality of sub-band pole-residue-eigenvalues; and
recalculating the sub-band macromodel for each of the plurality of sub-bands.

47. The program of claim 45, further comprising:
obtaining a frequency response of the multi-port passive circuit;
determining a plurality of original data-eigenvalues from the obtained frequency response of the multi-port passive circuit;
obtaining a macromodel frequency response of the multi-port broadband macromodel;
determining a plurality of macromodel data-eigenvalues from the obtained frequency response of the multi-port broadband macromodel; and
comparing the determined plurality of original data-eigenvalues with the plurality of macromodel data-eigenvalues.

48. The program of claim 47, further comprising:
identifying a difference between at least one original data-eigenvalue and a corresponding macromodel data-eigenvalue; and
re-determining the macromodel data-eigenvalue when the difference exceeds a predefined threshold.

49. The program of claim 48, wherein identifying the difference further comprises determining a difference in a magnitude of the original data-eigenvalue and a magnitude of the corresponding macromodel data-eigenvalue.

50. The program of claim 48, wherein identifying the difference further comprises determining a difference in a frequency location of the original data-eigenvalue and a frequency location of the corresponding macromodel data-eigenvalue.

51. The program of claim 48, wherein re-determining the macromodel data-eigenvalue further comprises:
identifying an error location, the error location corresponding to a frequency of the identified macromodel data-eigenvalue;
determining an error sub-band, the error sub-band having a frequency range around the error location;
determining a plurality of new poles and residues for the error sub-band; and
replacing corresponding macromodel poles and residues with the determined new poles and residues.

52. A circuit simulator which simulates response of a multi-port passive circuit over a broadband frequency range, comprising:
an input interface configured to receive a frequency response of the multi-port passive circuit;
a processor configured to:
determine a modeled frequency response from a multi-port broadband macromodel, the multi-port broadband macromodel originally having an associated plurality of original poles and residues;
determine a plurality of original pole-residue-eigenvalues corresponding to the determined original poles and residues;
identify at least one of the plurality of original pole-residue-eigenvalues having a value less than zero;
change the value of the at least one identified original pole-residue-eigenvalue to at least zero;
calculate at least one pole and residue of the multi-port broadband macromodel after the value of the at least one identified original pole-residue-eigenvalue is changed;
change an original pole and residue of the multi-port broadband macromodel to the calculated pole and residue; and
determine a second modeled frequency response and the multi-port broadband macromodel having the calculated pole and residue;
a memory configured to store the received frequency response of the multi-port passive circuit and the determined second modeled frequency response of the multi-port broadband macromodel; and
an output interface configured to communicate information corresponding to a comparison between the received frequency response and the determined second modeled frequency response-so that errors between a plurality of corresponding data-eigenvalues of the received frequency response and the determined second modeled frequency response are identified.
